(19) United States
(12) Patent Application Publication
(10) Pub. No.: US 2011/0059340 A1
(43) Pub. Date: Mar. 10, 2011

(54) Conductive Plastic Bipolar Battery or Capacitor with Siloxane Electrolyte

(76) Inventors: Thomas J. Dougherty, Waukesha, WI (US); Robert C. West, Madison, WI (US)

(21) Appl. No.: 12/783,333

(22) Filed: May 19, 2010

Related U.S. Application Data
(60) Provisional application No. 61/179,561, filed on May 19, 2009.
(60) Provisional application No. 61/303,502, filed on Feb. 11, 2010.

(51) Int. Cl. H01M 2/14; H01M 4/60; H01M 4/82; H01G 9/00; H01G 9/145; H01G 9/10; H01G 9/12; H01G 9/035

(52) U.S. Cl. 429/57; 429/212; 429/131; 429/120; 429/341; 29/623.4; 29/623.3; 29/623.2; 361/500; 361/503; 361/517; 361/521; 361/504

(57) ABSTRACT

The present invention includes a conductive plastic that is used as an electrode substrate in bipolar batteries. This conductive plastic has shown resistances as low as 1 ohm cm². Using a dry process for active material electrode construction, the conductive plastic allows for lamination of the dry oxide and carbons for cathodes and anodes necessary in the initial assembly of the cell. The bipolar electrodes are then able to be sealed. With this process, the product can then be assembled into a multi cell battery. The cell uses an organosilane or organosiloxane solvent electrolyte to prevent leakage.

### CROSS-REFERENCES TO RELATED APPLICATIONS

This application claims priority from U.S. Provisional Patent Application No. 61/179,561 filed May 19, 2009 and U.S. Provisional Patent Application No. 61/303,502 filed Feb. 11, 2010.

### STATEMENT REGARDING FEDERALLY SPONSORED RESEARCH

Not Applicable.

### BACKGROUND OF THE INVENTION

1. Field of the Invention

This invention relates to an energy storage device such as a bipolar battery or capacitor having a conductive polymeric material as an electrode substrate and that can be sealed to form a leak proof containment for the electrolyte.

2. Description of the Related Art

Present bipolar batteries are made with metal or semi metallic conductive electrodes. It has been a major problem both to find an electrode material that does not react with the active materials and that can be sealed to form a leak proof containment for the electrolyte.

Therefore, there is a need for an electrode material that does not react with the electrode active materials and that can be sealed to form a leak proof containment for the electrolyte.

### SUMMARY OF THE INVENTION

The present invention provides an energy storage device including a conductive plastic that is used as an electrode substrate in the energy storage device such as a bipolar battery or capacitor. This conductive plastic has shown resistances as low as 1 ohm cm². Using a dry process for active material electrode construction, the conductive plastic allows for lamination of the dry oxide and carbons for cathodes and anodes necessary in the initial assembly of a battery cell. The bipolar electrodes are then able to be sealed via the process of the invention. With this process, the product can then be assembled into a multi cell battery.

In one aspect, the energy storage device of the invention provides a heat laminated Maxwell dry process electrode to a conductive plastic.

In another aspect, the energy storage device of the invention provides a wet coating to a conductive plastic with tin oxide coating.

In yet another aspect, the energy storage device of the invention provides a stack of bipolar cells that include a conductive plastic electrode substrate and a Maxwell dry process electrode material, one cathode material electrode and one anode material electrode laminated to both sides of a bipolar cell with either a heat laminated process or a conductive binder.

In still another aspect, the energy storage device of the invention provides a separator with the approximate material composition of the electrode substrates and heat melt temperature that overhangs the electrodes and is folded on the ends to add extra melt material to allow for both a top and edge seal, or the same separator material layered to attain the same effect.

In yet another aspect, the energy storage device of the invention provides one or more sides of the electrode material that is allow pass through the end of the separator to allow for a conductive media to balance the cells.

In still another aspect, the energy storage device of the invention provides an opening for filling and venting that allows for future venting (duck-bill type vent).

In yet another aspect, the energy storage device of the invention provides conductive metal end plates to collect the current from the battery.

In still another aspect, the energy storage device of the invention provides a containment to place pressure on the electrodes that compresses the electrodes and helps conduct heat.

In yet another aspect, the energy storage device of the invention provides an electronic package that is incorporated on the end of the battery connected to the overhanging electrodes.

In still another aspect, the energy storage device of the invention provides a battery cell so constructed where the separator material hangs over the electrode by an amount to allow a second edge battery seal that melts all the separator material together (butt seal) and forms the outer edge containment of the battery.

In yet another aspect, the energy storage device of the invention provides a battery cell as described above that uses an organosilane or organosiloxane solvent electrolyte.

In still another aspect, the energy storage device of the invention provides a battery cell as described above that uses a polymerized siloxane electrolyte.

In yet another aspect, the invention provides the above process used on any battery or capacitor chemistry for anode and cathode.

In still another aspect, the energy storage device of the invention provides the above constructions and processes used on any 2-300 battery cell construction.

These and other features, aspects, and advantages of the present invention will become better understood upon consideration of the following detailed description, drawings and appended claims.

### BRIEF DESCRIPTION OF THE DRAWINGS

FIG. 1 is a side view of a bipolar three cell stack according to the invention.

FIG. 2 is a top view of the bipolar three cell stack of FIG. 1.

### DETAILED DESCRIPTION OF THE INVENTION

A battery cell construction according to the invention starts by applying a cathode material to one side of a conductive electrode substrate comprising a polyolefin matrix filled with conductive particles. Non-limiting examples of polyolefins include polyethylene and polypropylene and blends and copolymers thereof. Non-limiting examples of conductive particles include carbon particles such as graphite.

In one form, the electrode substrate comprises a blend of carbon-filled polyethylenes. For example, the electrode substrate can comprise a 40 wt. % blend of about 50 wt. % loaded conductive carbon-filled polyethylene with about a 60 wt. % blend of about 25 wt. % loaded conductive carbon-filled polyethylene having a resistance of less than about 30 ohm cm². Another embodiment of the electrode substrate can comprise about a 50 wt. % blend of about 50 wt. % loaded conductive carbon-filled polyethylene with about a 50 wt. % blend of about 25 wt. % loaded conductive carbon-filled polyethylene having a resistance of less than about 15 ohm cm². Another embodiment of the electrode substrate can comprise about a 60 wt. % blend of about 50 wt. % loaded conductive carbon-filled polyethylene with about a 40 wt. % blend of about 25 wt. % loaded conductive carbon-filled polyethylene having a resistance of less than about 10 ohm cm². Another embodiment of the electrode substrate can comprise about a 66 wt. % blend of about 50 wt. % loaded conductive carbon-filled polyethylene with about a 34 wt. % blend of about 25 wt. % loaded conductive carbon-filled polyethylene having a resistance of less than about 5 ohm cm². Total conductive carbon loadings in the carbon-filled polyethylene of about 25 wt. % to 50 wt. % are preferred.

One example preferred material is a carbon-filled high density polyethylene blend material obtained from Pure-Stat Technologies Inc. of Lewiston, Me., USA. The carbon-filled high density polyethylene blend material preferably has an internal resistance of between 0.1 and 100 ohm cm², more preferably between 0.1 and 50 ohm cm², more preferably between 0.1 and 30 ohm cm², more preferably between 0.1 and 20 ohm cm², more preferably between 0.1 and 10 ohm cm², and more preferably between 0.1 and 5 ohm cm². The carbon-filled high density polyethylene blend material preferably has a thickness of 0.001 to 0.100 inches, more preferably 0.001 to 0.050 inches, more preferably 0.001 to 0.030 inches, more preferably 0.001 to 0.020 inches, and more preferably 0.001 to 0.010 inches.

In the case of a lithium ion battery, the cathode material can include a binder, a conductive carbon, and an active cathode particulate material such as an oxide of cobalt, manganese, or nickel, or iron phosphate or other type cathode material. Non-limiting examples of active cathode particulate materials include layered oxides (such as lithium cobalt oxide or lithium nickel oxide), polyanions (such as lithium iron phosphate), or spinels (such as lithium manganese oxide). The thickness of the cathode material on the conductive electrode substrate can be about 5 to 500 microns.

In the case of a lithium ion battery, the cell construction continues by applying an anode material to the other side of the carbon-filled high density polyethylene blend material. The anode material can include a binder and an active anode particulate material such as titanates, hard carbon, or graphite. The thickness of the anode material on the conductive electrode substrate can be about 5 to 500 microns.

The process used to meld the anode material and the cathode material together can be a conductive acrylic binder or just the use of heat and/or pressure to form the bipolar plate. An example method for forming the anode material and the cathode material on opposite sides of the carbon-filled high density polyethylene blend material can be found in U.S. Patent Application Publication No. 2006/0109608 which is incorporated herein by reference along with other patent and publications referenced herein. An electrode produced by these methods can be called a ‘Maxwell dry electrode’ or a ‘Maxwell dry process electrode’. Using this method, a dry mix of a dry binder, a dry conductive carbon, and a dry active cathode particulate material can form a dry film of the cathode material on one side of the electrode substrate, and a dry mix of a dry binder and a dry active anode particulate material can form a dry film of the anode material on another side of the electrode substrate. Non-limiting examples of the dry binder include acrylics and fluoropolymers such as polytetrafluoroethylene.

Other batteries such as lead acid, and nickel metal hydride can also be made with this process but surface treatment such as wet tin or tin oxide coating would be necessary for a carbon-filled high density polyethylene blend material to prevent oxidation of the carbon by the PbO₂ which comprises the positive electrode active material in a lead acid battery.

Each bipolar plate is stacked on a separator that is folded on the edges to form folds to increase the amount of separator material in the sealing area. Preferably, one to ten folds are used for the edges of the separator. More than one separator can also be used to attain the same thickness but this adds resistance. This is done to add nonconductive material to the seal area and also to allow for an edge of material that would reduce any conductive edges to short. These cell stacks are then packaged in a containment that can apply a pressure, either by vacuum or by pressure of the end walls of the containment. Cell stacks can be from 3 cells to 300, but cell stacks of 10 to 100 are preferred to get voltages that allow for quality manufacture.

In the case of a lithium ion battery, the separator is preferably made of an electrically insulating polyolefin (such as polyethylene or polypropylene) that prevents electrons from flowing directly from anode to cathode, allowing electrons instead to flow out to the electrical load. These separators have to be porous as well, to allow lithium ions to pass through. The thickness of the separator can be about 10 to 100 microns.

One edge of the cell conductive plastic is extended for lithium or capacitor type cells so that a cell to cell balancing circuit can be added to that end of the electrode. Also, a second side has an opening for filling the cell with electrolyte.

In the case of a lithium ion battery, liquid electrolytes including a lithium salt, such as LiPF₆, LiBF₄ or LiClO₄ in an organic solvent, such as ethylene carbonate can be used. A liquid electrolyte conducts lithium ions, acting as a carrier between the cathode and the anode when a lithium ion battery passes an electric current through an external circuit.

One preferred electrolyte is an organosilane or organosiloxane solvent with lithium salts that have a molecular size and viscosity as not to bleed through the plastic membranes of the cell as do some carbonate solvents. The electrolyte is also much safer than the carbonate solvents and allows for easier filling. This electrolyte is presently added after the cell is made but could be added as a solid electrolyte in a polymerized structure or polymerized after it is added to the cell. This electrolyte has the ability to also go to higher voltages, taking advantage of the carbon plastic high working voltage. Voltages of 4.5 to 5.5 volts are now possible with this electrolyte.

The preferred electrolyte is described in U.S. Pat. Nos. 7,466,539 and 7,612,985. This electrolyte includes an organosilicon material that is ion-conducting. Particularly preferred materials are the organosilanes and organosiloxanes, such as those having oligoethyleneoxide moieties (e.g., between 2 and 500 repeating units). These materials can have linear, branched, hyper-branched or cross-linked structure, and can be liquid (of varied viscosity), gel or solid. There may be just one silicon atom in the material (as is the case in (CH₃)₃SiO—(CH₂CH₂O)₃—CH₃. The terminal groups are not critical and may generally be alkyl or substituted alkyl. Alternatively, the organosilicon material may have two or more silicon atoms like in (CH₃)₃SiO—(CH₂CH₂O)₃—Si(CH₃)₃, or in disiloxane CH₃(OCH₂CH₂)₃OCH₂CH₂CH₂—Si(CH₃)₂OSi(CH₃)₂—CH₂CH₂CH₂O(CH₂CH₂O)₃CH₃, or have a polysiloxane chain structure with side groups containing such oligoethyleneoxide moieties as below in Formula (I). The length of the polysiloxane backbone is not critical.

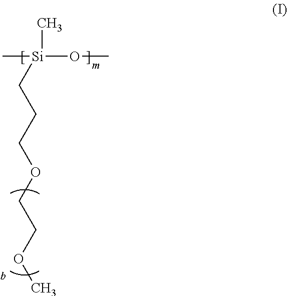

An appropriate salt (preferably lithium salt) is added to the organosilicon material to produce a preferred organosilicon electrolyte material. Lithium salts such as lithium-bis-oxalatoborate, lithium-tetrafluoroborate, and lithium-(trifluoromethylsulfonyl)-imide are suitable, but the invention is not restricted to just these salts.

Thus, a non-limiting example bipolar battery or capacitor according to the invention uses the following materials in cell construction: (1) an electrode substrate comprising a carbon-filled high density polyethylene blend electrode material obtained from Pure-Stat Technologies Inc. of Lewiston, Me., USA having a low internal resistance of between 0.1 and 100 ohm cm²; (2) a Maxwell dry electrode process using lithium cathode material and anode materials, or any battery or capacitor material that can be made into a bipolar battery; (3) a polyolefin (e.g., polyethylene, polypropylene) separator or other like plastic that can be heat sealed, or other plastic welding process, to the carbon-filled high density polyethylene blend electrode material obtained from Pure-Stat Technologies Inc.; (4) an end electrode that conducts the electricity from the conductive plastic to the electrical circuit; (5) an electrolyte based on the organosilane or organosiloxane solvents described above; (6) an electronics circuit heat sealed to the carbon-filled high density polyethylene blend electrode material obtained from Pure-Stat Technologies Inc.; and (7) an enclosure to house the above battery.

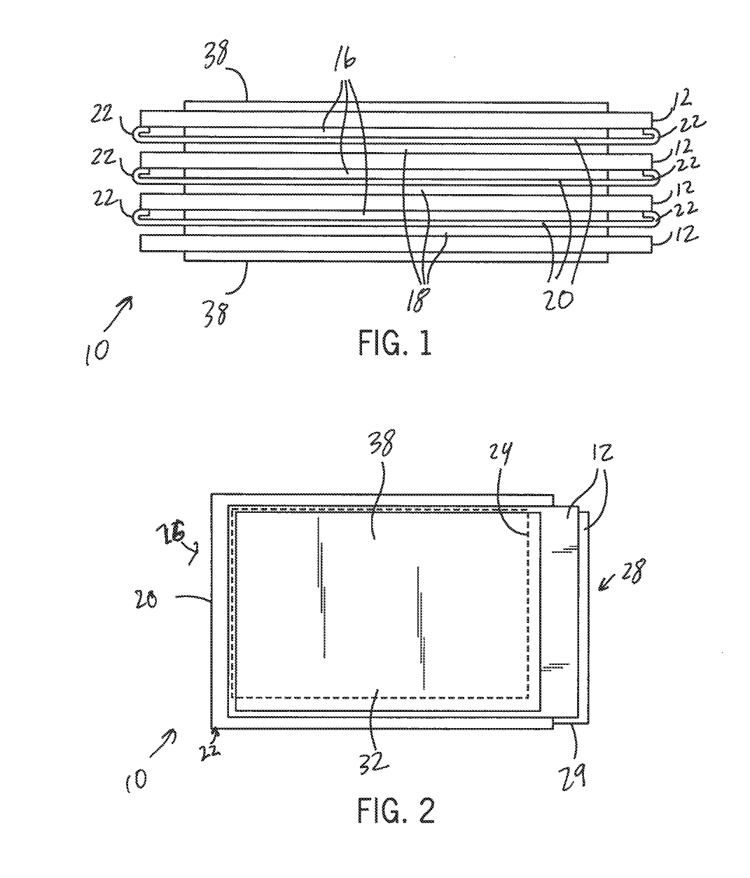

Turning now to FIGS. 1 and 2, one example embodiment of the present invention is a battery cell 10. One example method for manufacturing the battery cell 10 includes the steps of coating a conductive substrate 12 with a cathode material 16 on one side of the substrate 12, and coating the conductive substrate 12 on the other side with a suitable anode material 18. As can be seen in FIG. 1, once the conductive substrate 12 is coated with the cathode material 16 and anode material 18, the substrate 12 is stacked on a separator 20 that is folded on the edges 22. Folding the edges 22 of the separator 20 is done to increase the amount of separator material 20 in heat sealing area 24 and to add non-conductive material to the sealing area 24. This configuration also reduces the chance that any conductive areas would short. Suitable separator materials 20 include any plastic that can be heat sealed or welded to the conductive substrate 12 of the present invention. The separator 20 may have approximately the same material composition of the matrix of the conductive substrate 12, and preferably has approximately the same melting temperature as the conductive substrate 12. One suitable example material for the separator is a polyolefin or polyolefin blend or copolymer. Preferably, a melting temperature of the separator is within 25° C. of a melting temperature of the conductive electrode substrate, more preferably within 15° C., more preferably within 10° C., and more preferably within 5° C. One example separator comprises polyethylene.

As shown in FIG. 2, the separator material 20 at one side 26 of the battery cell 10 is sealed, and the conductive substrate 12 may be extended on the other side 28 of the battery cell 10 so that a cell-to-cell balancing circuit (not shown) can be added to an end 29 of the conductive substrate 12. A portion of the battery cell 10 is left open as a vent opening 32 of a vent (such as a duck-bill type vent) for filling the battery cell 10 with electrolyte. The top and bottom of the stack are covered by an end electrode 38 that conducts electricity from the conductive plastic substrate 12 to an electrical circuit (not shown) or other device to be powered. The end electrode 38 can comprise a conductive metal or alloy such as aluminum, copper, or steel. The battery cell 10 as shown in FIGS. 1 and 2 is then packaged using a system that applies vacuum pressure or physical pressure to the end walls of the battery cell 10. The number of stacks in a battery cell 10 can be any number sufficient to provide voltages useful in manufacture, preferably from 3 to 300, more preferably from 10 to 100. After the battery cell 10 is packaged and sealed, it is enclosed in a suitable housing. Suitable housings are known to those skilled in the art.

The conductive substrate 12 of the present invention has a unique property that allows it to be very effective and useful in batteries, and especially lithium batteries. This property is called Positive Temperature Coefficient Resistance (PTCR). Specifically, when the temperature of the conductive substrate 12 gets to a specific level, caused by an increase in current density, the substrate 12 starts to limit current flow. At a high enough level of power, the resistance of the substrate 12 goes very high, and protects the battery cell from short circuit. Currently, circuits must be protected from short circuits or surges by incorporating another device into the circuit.

A battery was assembled as shown in FIGS. 1 and 2 with one open end using an electrolyte based on the organosilane or organosiloxane solvents described above which can be placed through the open end before heat sealing the open end. A heat knife was used to heat seal the separator 20 and conductive substrate 12 materials together. No solvent leakage through the plastic surface was observed.

In the case of a lithium ion capacitor according to the invention, the conductive substrate as described above can be used, activated carbon can be used as the cathode material, and the anode material can comprise a carbon material which is pre-doped with lithium ions. The electrolyte used in the lithium ion capacitor can be a lithium-ion salt solution such as LiPF₆, LiBF₄ or LiClO₄, and a separator material as described above can be used to avoid direct electrical contact between anodes and cathodes of adjacent cells.

Thus, the invention provides an energy storage device such as a bipolar battery or capacitor having a conductive polymeric material as an electrode substrate and that can be sealed to form a leak proof containment for the electrolyte.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. An energy storage device comprising:
a conductive electrode substrate comprising a polyolefin filled with conductive particles, wherein the conductive electrode substrate has an internal resistance of less than about 100 ohm cm²;
a cathode material disposed on a first side of the conductive electrode substrate; and
an anode material disposed on an opposite second side of the conductive electrode substrate.

2. The energy storage device of claim 1 wherein:
the cathode material comprises a dry mix of a dry binder, a dry conductive carbon, and a dry active cathode particulate material, and
the anode material comprises a dry mix of a dry binder and a dry active anode particulate material.

3. The energy storage device of claim 1 further comprising:
a second conductive electrode substrate comprising a polyolefin filled with conductive particles, wherein the second conductive electrode substrate has an internal resistance of less than about 100 ohm cm²;
a second cathode material disposed on a first side of the second conductive electrode substrate;
a second anode material disposed on an opposite second side of the second conductive electrode substrate; and
a separator comprising the polyolefin,
wherein the separator is positioned between the anode material disposed on the conductive electrode substrate and the second cathode material disposed on the second conductive electrode substrate.

4. The energy storage device of claim 3 wherein:
perimeter edges of the separator overhang the conductive electrode substrate and the second conductive electrode substrate.

5. The energy storage device of claim 3 wherein:
the separator includes folded perimeter edges, and
the energy storage device includes a heat seal between the folded perimeter edges of the separator, the conductive electrode substrate, and the second conductive electrode substrate.

6. The energy storage device of claim 5 wherein:
the perimeter edges of the separator overhang the conductive electrode substrate and the second conductive electrode substrate to allow a second edge battery seal that melts all the separator material together and forms an outer edge containment of the energy storage device.

7. The energy storage device of claim 3 further comprising:
a second separator comprising the polyolefin,
wherein the second separator is positioned adjacent the separator and between the anode material disposed on the conductive electrode substrate and the second cathode material disposed on the second conductive electrode substrate,
wherein perimeter edges of the second separator overhang the conductive electrode substrate and the second conductive electrode substrate, and
wherein the perimeter edges of the separator and the second separator include a heat seal between the separator, the second separator, the conductive electrode substrate and the second conductive electrode substrate.

8. The energy storage device of claim 7 further comprising:
a vent opening in the heat seal.

9. The energy storage device of claim 3 wherein:
a melting temperature of the separator is within 25° C. of a melting temperature of the conductive electrode substrate.

10. The energy storage device of claim 3 wherein:
at least one side of the conductive electrode substrate and at least one side of the second conductive electrode substrate pass beyond an end of the separator, and
the energy storage device includes conductive media to balance a first cell including the conductive electrode substrate and a second cell including the second conductive electrode substrate.

11. The energy storage device of claim 3 further comprising:
a first conductive current collecting end plate connected to the conductive electrode substrate, and
a second conductive current collecting end plate connected to the second conductive electrode substrate.

12. The energy storage device of claim 3 further comprising:
a housing for placing pressure on the conductive electrode substrate and the second conductive electrode substrate such that the conductive electrode substrate and the second conductive electrode substrate better conduct heat.

13. The energy storage device of claim 3 further comprising:
an organosilane or organosiloxane solvent electrolyte.

14. The energy storage device of claim 3 further comprising:
a polymerized siloxane electrolyte.

15. A method for forming an energy storage device, the method comprising:
(a) providing a conductive electrode substrate comprising a polyolefin filled with conductive particles, wherein the conductive electrode substrate has an internal resistance of less than about 100 ohm cm²;
(b) providing a cathode material comprising a dry mix of a dry binder, a dry conductive carbon, and a dry active cathode particulate material;
(c) providing an anode material comprising a dry mix of a dry binder and a dry active anode particulate material;
(d) adhering the cathode material on a first side of the conductive electrode substrate; and
(e) adhering the anode material on an opposite second side of the conductive electrode substrate.

16. The method of claim 15 wherein:
step (d) comprises heat laminating the cathode material on the first side of the conductive electrode substrate; and
step (e) comprises heat laminating the anode material on the second side of the conductive electrode substrate.

17. The method of claim 15 wherein:
step (d) comprises compressing the cathode material on the first side of the conductive electrode substrate; and
step (e) comprises compressing the anode material on the second side of the conductive electrode substrate.

18. The method of claim 15 wherein:
the active cathode particulate material is selected from layered oxides, polyanions, spinels and mixtures thereof.

19. The method of claim 18 wherein:
the active anode particulate material is selected from titanates, hard carbon, graphite and mixtures thereof.

20. The method of claim 18 wherein:
the layered oxides, polyanions and spinels include lithium.

21. The method of claim 15 further comprising:
(f) adhering second cathode material on a first side of a second conductive electrode substrate;
(g) adhering second anode material on an opposite second side of the second conductive electrode substrate;
(h) placing a separator between the anode material disposed on the conductive electrode substrate and the second cathode material disposed on the second conductive electrode substrate; and
(i) heat sealing the separator, the conductive electrode substrate, and the second conductive electrode substrate.

22. The method of claim 21 wherein:
step (i) comprises folding perimeter edges of the separator, and heat sealing the folded perimeter edges of the separator, the conductive electrode substrate, and the second conductive electrode substrate.
